(19) United States
(12) Patent Application Publication
(10) Pub. No.: US 2006/0090939 A1
(43) Pub. Date: May 4, 2006

(54) Removable snowmobile repositioning device

(76) Inventor: Thomas L. White, Traverse City, MI (US)

Correspondence Address: Michael D. Wiggins, 950 Harmon Street, Birmingham, MI, 48009, US

(21) Appl. No.: 10/979,259

(22) Filed: Nov. 2, 2004

(51) Int. Cl. B62D 55/04

(52) U.S. Cl. 180/9.26

(57) ABSTRACT

A snowmobile repositioning device for a snowmobile includes a front ski and a front steering member and mounting plate that connect a front suspension to the front ski. At least one of the front steering member and mounting plate includes a first opening. A wheel assembly is rotatably supported by an axle. A radially-projecting frame portion is connected to the axle. A first axial projection extends from the radially-projecting frame portion and is removably received in the first opening.

### FIELD OF THE INVENTION

The present invention relates to snowmobiles, and more particularly to repositioning device for snowmobiles.

### BACKGROUND OF THE INVENTION

Snowmobiles are used to travel over snow-covered surfaces. Snowmobiles typically include a frame and an engine that is supported by the frame. A front portion of the frame rests on a front suspension that typically includes front shocks and front control arms that are connected to front skis. A rear portion of the frame is connected by a rear suspension to a rear track. Handlebars allow a snowmobile rider to adjust the angle of the front skis to effect steering changes. The handlebars also typically include throttle and brake controls.

Snowmobiles are typically stored inside garages or specially built trailers and normally need to be moved in the vicinity of the storage space. Additionally, snowmobiles may be transported over longer distances using a trailer that is towed behind a tow vehicle. When the snowmobile is removed from the trailer, the snowmobile rider can start and drive the snowmobile. In some circumstances, however, the snowmobile may not be located near a snow covered surface. If the rider repositions the snowmobile on a rough surface such as asphalt, concrete, gravel, grass and the like, the front skis and/or rear track may be damaged and/or experience excessive wear. The surface upon which the snowmobile travels may be damaged. Furthermore, it is difficult to control the snowmobile on these types of surfaces, which may increase the risk of accidents.

### SUMMARY OF THE INVENTION

A snowmobile repositioning device for a snowmobile that includes a front ski and a front steering member and mounting plate that connect a front suspension to the front ski. At least one of the front steering member and the mounting plate include a first opening. A wheel assembly is rotatably supported by an axle. A first axial projection extends from the axle and is removably received in the first opening.

In other features, the first axial projection has a first cross section that allows the first axial projection to be removably received in the first opening and to support the axle at an angle that is substantially parallel to a plane defined by the front ski. A second axial projection extends from the radially-projecting frame portion and is also received in the first opening. The first and second axial projections have a generally circular cross section.

In still other features, the first axial projection maintains an angular position of the radially-projecting frame portion relative to the axle.

A snowmobile repositioning device for a snowmobile that includes a frame that is connected by a rear suspension to a rear frame member having an opening and a rear track comprises first and second wheel assemblies. An axle supports the first and second wheel assemblies. An axle member is rotatably connected to the axle. A radial frame portion extends from the axle member. A first axial projection that extends from the frame portion is removably received in the opening in the rear frame member.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of snowmobile repositioning devices according to some implementations of the present invention that are removably connected to front skis and/or the steering spindle and a rear track of a snowmobile;

FIG. 2A is a perspective view of a left front ski and a left front steering member, which has a left front repositioning device attached thereto;

FIG. 2B is an end view of a protective sleeve on a projection;

FIG. 3 is a perspective view of the left front ski of FIG. 2A with the left front repositioning device spaced from the left front ski and left front frame member;

FIG. 4 is a perspective view of a rear frame, rear idler or carrier wheels, an inside surface of a rear track and a rear repositioning device;

FIG. 5 is a perspective view that is similar to FIG. 4 with the rear repositioning device partially removed;

FIG. 6 is a perspective view of a left front ski and a left front steering member according to some implementations, which has a left front repositioning device attached thereto; and

FIG. 7 is a perspective view illustrating an alternate wheel assembly of FIG. 6.

### DETAILED DESCRIPTION OF THE PREFERRED EMBODIMENTS

The following description of the preferred embodiment(s) is merely exemplary in nature and is in no way intended to limit the invention, its application, or uses.

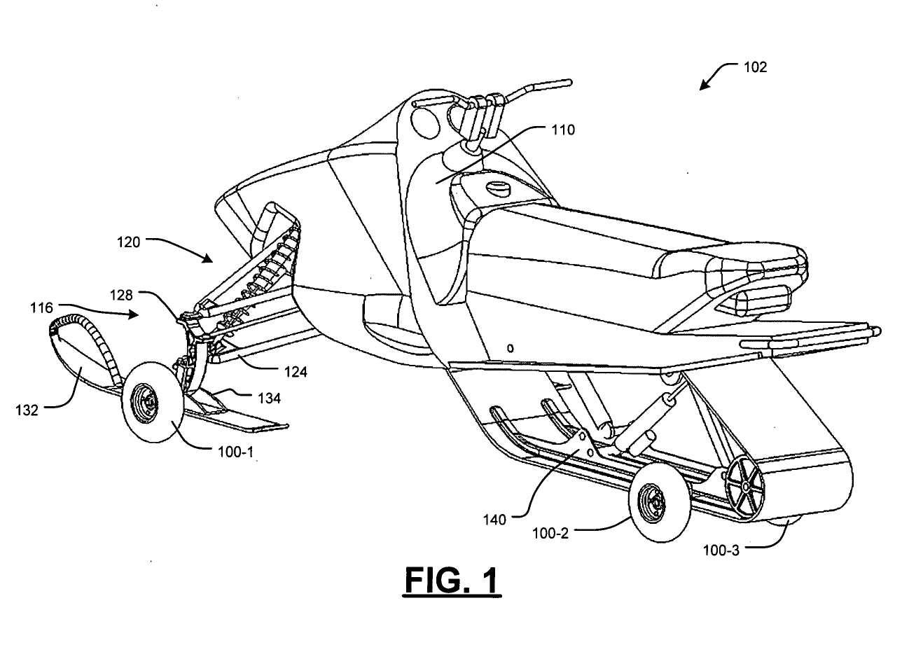

Referring now to FIG. 1, left front, left rear and right rear repositioning devices 100-1 and 100-2 (collectively repositioning devices 100) are removably attached to a snowmobile 102. The snowmobile 102 includes an engine (not shown) that is located within a body 110 and is supported by a frame (not shown). A front portion of the frame is supported by a front suspension 116. The front suspension 116 includes front shocks 120 and front control arms 124. Lower ends of the front shocks 120 and control arms 124 are connected to an upper portion of a left front steering member 128. A lower portion of the left front frame member 128 is pivotably connected to a left front ski 132 by a mounting plate 134. A pin (not shown) extends through a lower bore in the left front frame member 128 to opposite surfaces 134A and 134B of the mounting plate. A bottom surface 134C is attached to the ski 132.

The left front repositioning device 100-1 is removably attached to the left front frame member 128. The rear repositioning device 100-2 is also removably attached to a rear frame member 140, as will be described below. A right front repositioning device has a similar structure as the left front repositioning device. The repositioning devices 100 can be attached to and removed from the snowmobile 102 quickly and easily. The repositioning devices 100 do not require tools for attachment and/or removal from the snowmobile 102 and the machine does not “rest” on the repositioning devices. The devices temporarily attach and do not require modification or additional hardware to be added to the machine or chassis for the purpose of attachment.

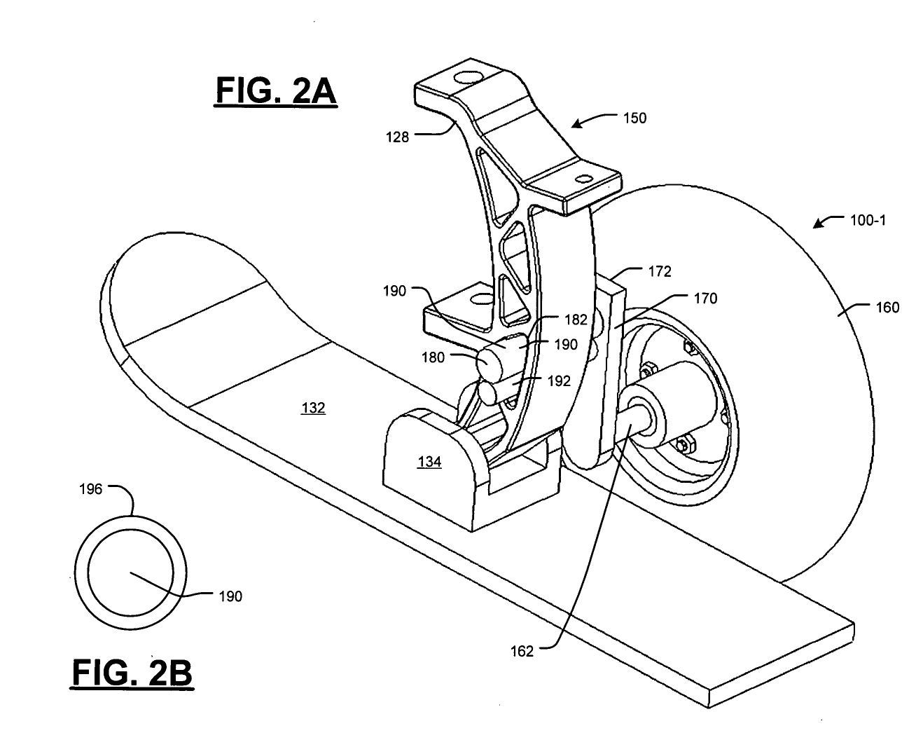

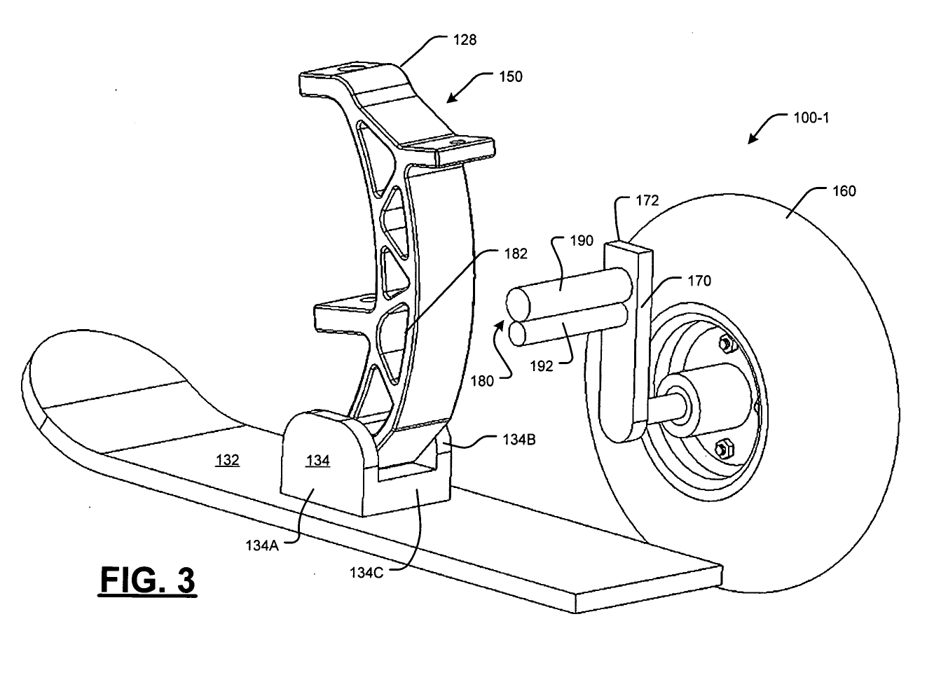

Referring now to FIGS. 2A, 2B, and 3, the left front ski 132 that is connected to the left front frame member 128 is shown in further detail. The left front repositioning device 100-3 is attached to an inside surface 150 of the left front frame member 128. The left front repositioning device 100-3 includes a wheel assembly 160 that rotates about an axle 162. A radial frame portion 170 is connected to one end of the axle 162 and extends radially therefrom. A distal end 172 of the radial frame portion 170 includes a first mating member 180 that extends axially therefrom and mates with the front left frame member 128.

In the embodiment shown, the left front frame member 128 includes openings 182 and the first mating member 180 includes one or more projections 190 that fit snugly within the openings 182. For example, the openings 182 may have a generally triangular shape as shown in FIG. 2A, although any other shape may be used. The first mating member 180 includes first and second projections 190 and 192 that have a generally circular cross section, although other shapes may be used depending on manufacturing capability and adaptation requirements of current and future snowmobiles. The first projections 190 may have a larger circular cross section than the second projection 192. The mating member 180 and the opening 182 substantially maintain an angular position of the radial frame portion 170 relative to the axle 162.

In one implementation, the projections 190 and 192 may be covered with a protective material to reduce potential damage to the left front frame member 128. For example, a protective sleeve 196 may be fitted over the projection 190, as shown in FIG. 2B. The protective sleeve 196 may be made of plastic, Teflon, rubber, or other suitable materials. The right front repositioning device 100-3 may have the same construction as the left front frame member 100-2. The left and right front repositioning devices 100-1 and 100-2 can also be attached from an outer side of the left and right front frame members.

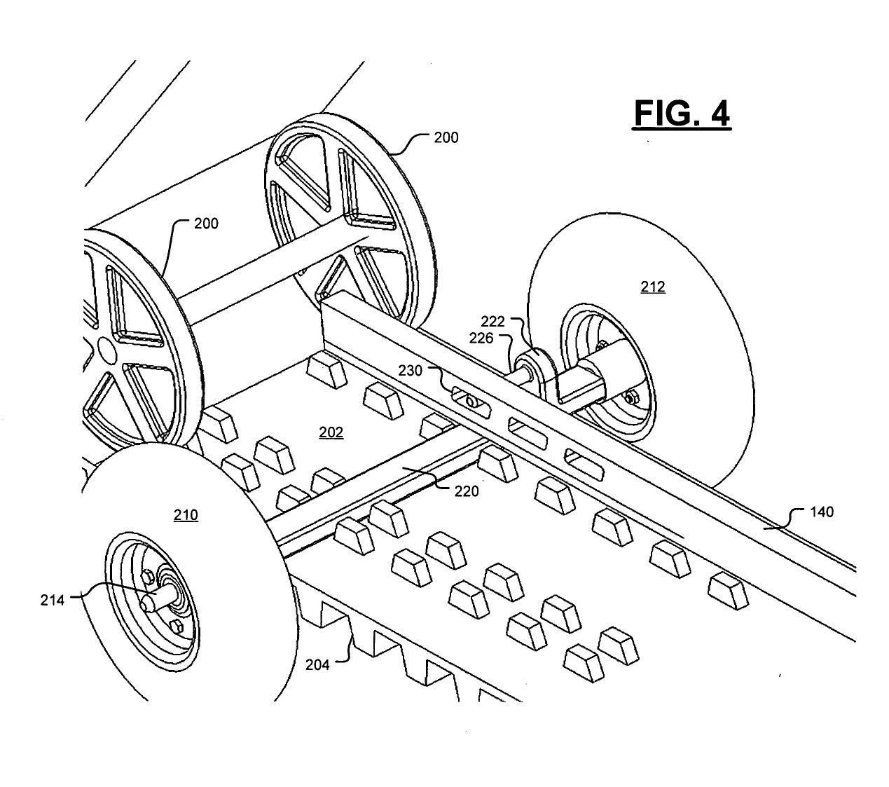

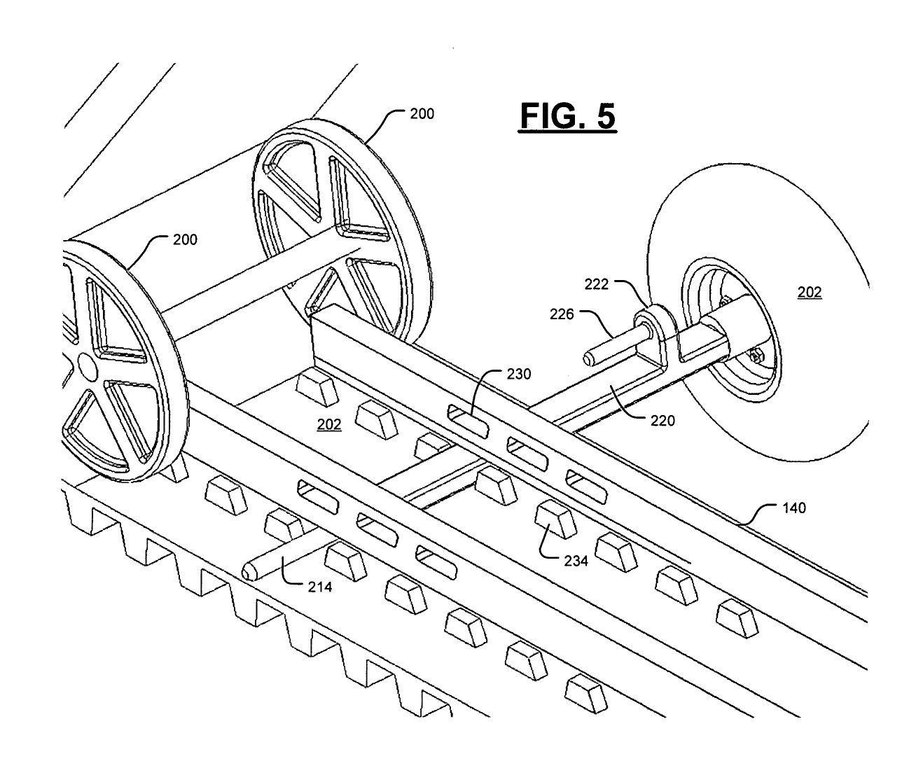

Referring now to FIGS. 4 and 5, the rear frame member 140 that is connected by a rear suspension to the frame is shown. Rear carrier wheels 200 contact an inside surface 202 of a rear track 204. The rear repositioning device 100-3 includes first and second wheel assemblies 210 and 212, which rotate about an axle 214. An axle member 220 is connected to the axle 214 and includes a radial frame portion 222 that extends radially from the axle member 220. A mating member 226 extends axially from a distal end of the radial frame portion 222 and is received by an opening 230 in the rear frame member 140. In some implementations, the rear track 204 includes an array of inwardly-directed projections 234 that engage sides of the axle member 220. The exact shape, number and position of the mating member 226 may vary depending on snowmobile brand, model and model year.

In use, when the snowmobile 102 needs to be repositioned, the repositioning devices 100 are installed. A front end and/or one side of the snowmobile 102 is raised to a sufficient height. The mating member 180 of the left front repositioning device 100-1 is inserted in the opening 182 of the front steering member 128. A similar approach is used for the right front repositioning device. The rear of the snowmobile 102 is raised and the rear repositioning device 100-3 is inserted between the rear track 204 and the frame member 140. The mating member 226 is inserted into the opening 230 in the frame member 140. The wheel 210 is then slipped on to the axle 214. Removal of the repositioning devices can be accomplished by reversing these steps.

As can be appreciated, while the repositioning devices that are shown in the Figures are fabricated, the repositioning devices can be made using other approaches. For example, portions of the repositioning devices can be cast or molded. Still other methods of fabrication can be used.

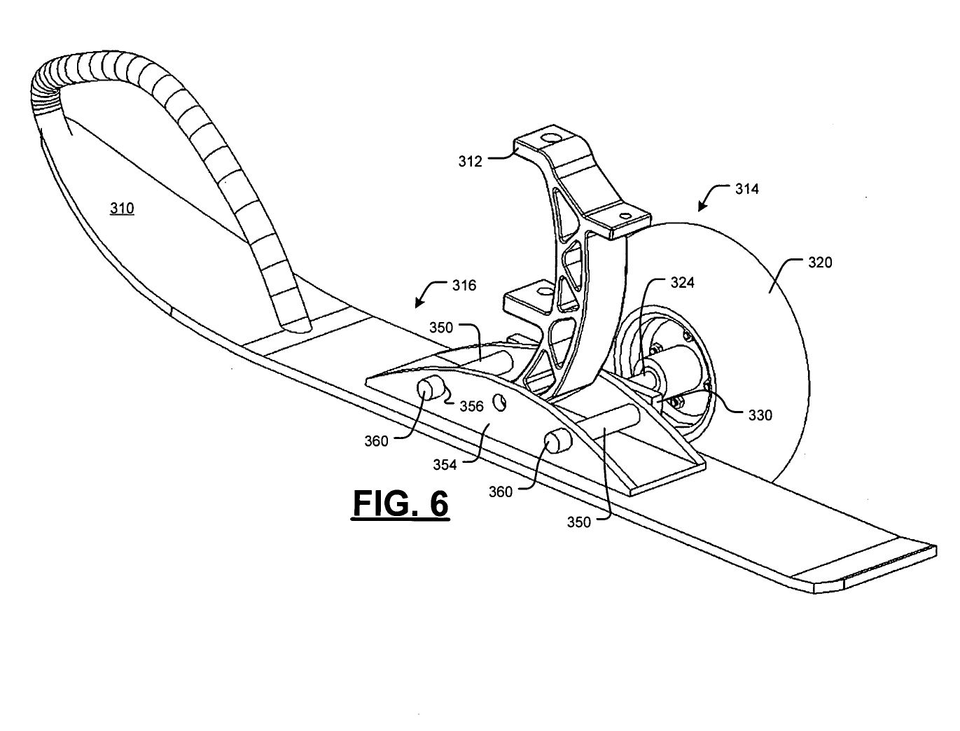

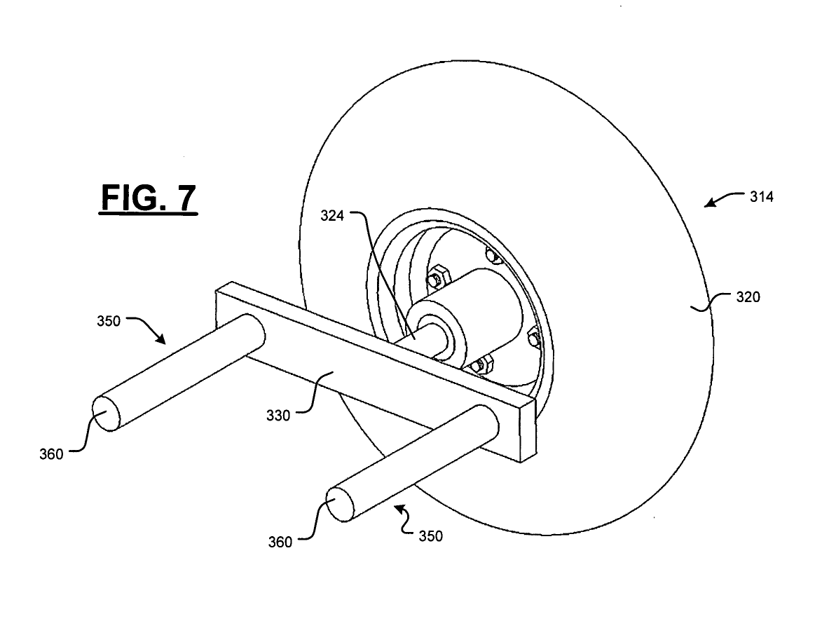

Referring now to FIGS. 6 and 7, an alternate right front ski 310 that is connected to a right front frame member 312 is shown in further detail. The right front repositioning device 314 is attached to an outside (or inside) surface 316 of a right front frame member 312. The right front repositioning device 314 includes a wheel assembly 320 that rotates about an axle 326. A radial frame portion 330 is connected to one end of the axle 326 and extends radially therefrom. Ends of the radial frame portion 330 include mating members 350 that extend axially therefrom and mate with holes in a mounting plate 354, which pivotably couples with the front right frame member 312.

In the embodiment shown, the right front frame member 312 includes openings 356 and the mating members 350 include one or more projections 360 that fit snugly within the openings 356. For example, the openings 356 may have a generally circular shape as shown in FIG. 6, although other shapes may be used. In one implementation, the projections 360 may be covered with a protective material to reduce potential damage to the right front frame member 128 and/or mounting plate 354. For example, a protective sleeve 196 may be fitted over the projection 360 in a manner similar to that shown in FIG. 2B. The protective sleeve 196 may be made of plastic, Teflon, rubber, or other suitable materials. The left front repositioning device may have the same construction as the right front frame member described above. The left and right front repositioning devices can also be attached from an inner side of the left and right front frame members. In some implementations, the radial frame portion can be omitted and the axle can be extended and directly inserted into holes in either the mounting plate or frame member.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

What is claimed is:

1. A snowmobile repositioning device for a snowmobile that includes a front ski and a front steering member and a mounting plate that connect a front suspension to the front ski, comprising:
a wheel assembly;
an axle that rotatably supports the wheel assembly;
a first axial projection that extends from the axle and that is removably received in a first opening in at least one of the mounting plate and/or the front steering member.

2. The snowmobile repositioning device of claim 1 further comprising a radially-projecting frame portion that is connected to the axle, wherein the first axial projection extends from the radially-projecting frame portion.

3. The snowmobile repositioning device of claim 1 wherein the first axial projection has a first cross section that allows the first axial projection to be removably received in the first opening and to support the axle at an angle that is substantially parallel to a plane defined by the front ski.

4. The snowmobile repositioning device of claim 2 further comprising a second axial projection that extends from the radially-projecting frame portion and that is also received in one of the first opening or a second opening in at least one of the mounting plate and/or the front steering member.

5. The snowmobile repositioning device of claim 4 wherein the first and second axial projections have a generally circular cross section.

6. The snowmobile repositioning device of claim 2 wherein the first axial projection maintains an angular position of the radially-projecting frame portion relative to the axle.

7. The snowmobile repositioning device of claim 1 wherein the mounting plate includes the first opening.

8. The snowmobile repositioning device of claim 1 wherein the front steering member includes the first opening.

9. A system, comprising:
a snowmobile that includes:
a front ski;
a front suspension;
a front steering member and a mounting plate that connect the front suspension to the front ski, wherein at least one of the front steering member and/or the mounting plate includes a first opening; and
a repositioning device that includes:
a wheel assembly;
an axle that rotatably supports the wheel assembly; and
a first axial projection that extends from the axle and that is received in the first opening.

10. The system of claim 9 further comprising a radially-projecting frame portion that is connected to the axle, wherein the first axial projection extends from the radially-projecting frame portion.

11. The system of claim 9 wherein the first axial projection has a first cross section that allows the first axial projection to be removably received in the first opening and to support the axle at an angle that is substantially parallel to a plane defined by the front ski.

12. The system of claim 10 further comprising a second axial projection that extends from the radially-projecting frame portion and that is also received in at least one of the first opening and a second opening in at least one of the front steering member and/or the mounting plate.

13. The system of claim 12 wherein the first and second axial projections have a generally circular cross section.

14. The system of claim 10 wherein the first axial projection maintains an angular position of the radially-projecting frame portion relative to the axle.

15. The system of claim 9 wherein the snowmobile further comprises:
a rear frame member that includes an opening; and
a rear track.

16. The system of claim 11 further comprising a rear repositioning device includes:
first and second wheel assemblies;
an axle for supporting the first and second wheel assemblies;
an axle member that is rotatably connected to the axle;
a frame portion that extends radially from the axle member; and
a second axial projection that is removably received in the opening in the rear frame member.

17. The system of claim 15 wherein the axle member is received between the rear frame and the rear track.

18. The system of claim 15 wherein the rear track includes drive projections and wherein the drive projections engage the axle member to limit movement of the rear track repositioning device.

19. A snowmobile repositioning device for a snowmobile that includes a frame that is connected by a rear suspension to a rear frame member having an opening and a rear track, comprising:
first and second wheel assemblies;
an axle for supporting the first and second wheel assemblies;
an axle member that is rotatably connected to the axle;
a radial frame portion that extends from the axle member; and
a first axial projection that extends from the frame portion and that is removably received in the opening in the rear frame member.

20. The snowmobile repositioning device of claim 19 wherein the axle member is received between the rear frame and the rear track.

21. The snowmobile repositioning device of claim 19 wherein the rear track includes drive projections and wherein the drive projections engage the axle member to limit movement of the rear track repositioning device.

22. The snowmobile repositioning device of claim 19 wherein the first axial projection maintains an angular position of the radially-projecting frame portion relative to the axle.
